(19) United States
(12) Patent Application Publication
(10) Pub. No.: US 2007/0231470 A1
(43) Pub. Date: Oct. 4, 2007

(54) Methods of producing composite material, filter and diffusion layer of fuel cell

(75) Inventors: Toshiki Koyama, Ueda-shi (JP); Masamitsu Miyashita, Ueda-shi (JP); Yoshitaka Matsui, Ueda-shi (JP)

Correspondence Address: BIRCH STEWART KOLASCH & BIRCH, PO BOX 747, FALLS CHURCH, VA, 22040-0747, US

(73) Assignees: Shinano Kenshi Kabushiki Kaisha; Shinano Kenshi Kabushiki Kaisha

(21) Appl. No.: 11/729,803

(22) Filed: Mar. 30, 2007

(30) Foreign Application Priority Data
Mar. 30, 2006 (JP) 2006-095993

(51) Int. Cl. B05D 5/12

(52) U.S. Cl. 427/115

(57) ABSTRACT

The composite material is constituted by a substrate and a carbonized nanofiber layer and capable of being widely applied. The method of producing the composite material comprises the steps of: disposing an electrically conductive substrate on an electrode plate of an electro spinning apparatus; spraying a polymer solution or a molten polymer, to which high voltage is applied from a capillary of a capillary electrode of the electro spinning apparatus, toward the substrate on the electrode plate so as to form a large number of nanofibers on the substrate; and burning the substrate, on which a large number of the nanofibers have been formed, so as to form a carbonized nanofiber layer on the substrate.

### BACKGROUND OF THE INVENTION

The present invention relates to methods of producing a composite material, a filter and a diffusion layer of a fuel cell.

A structure of a cell of a conventional fuel cell is shown in FIG. 8.

In the cell 10, a symbol 12 stands for an electrolytic membrane. A cathode layer 14 is formed on one side face of the electrolytic membrane 12; an anode layer (a fuel electrode) 16 is formed on the other side face thereof. Electrode plates (not shown) are respectively attached to the cathode layer 14 and the anode layer 16. Lead wires (not shown) are connected to the electrode plates.

A fuel and oxygen or an oxygenic gas (an oxidizing agent) are fed to the cell 10, so that an oxidation-reduction reaction occurs through the electrolytic membrane 12 and an electromotive force can be generated.

Electrode materials 14a and 16a, in each of which a catalystic metal for accelerating electrode reaction is supported, are respectively provided to the cathode layer 14 and the anode layer 16. The electrode plates are respectively attached to the electrode materials 14a and 16a so as to form electrodes.

For example, diffusion layers 14b and 16b are made of carbon cloth or carbon paper, which is capable of diffusing the fuel and the gas. Catalystic layers 14c and 16c are respectively formed on the diffusion layers 14b and 16b.

The catalystic layers 14c and 16c are formed by the steps of: preparing carbon powder, which supports the catalystic metal, e.g., platinum, ruthenium; mixing the carbon powder supporting the catalystic metal with a solvent, e.g., nafion solution, to form into a paste; applying the paste to the diffusion layers 14b and 16b; and warming the diffusion layers 14b and 16b, to which the paste has been applied, to volatilize the solvent (see Japanese Patent Kokai Document No. 6-20710).

By the structure in which the catalyst layers 14c and 16c are formed by applying the carbon powder supporting the catalystic metal to the diffusion layers 14b and 16b made of the carbon cloth or carbon paper, aeration and ventilation cannot be well performed. Especially, moisture generated on the cathode side is apt to be liquefied in the diffusion layer 14b, so that clogging easily occurs. Therefore, feeding air (oxygen) is obstructed, and output power must be decreased. Electrode reaction is accelerated with increasing current density, and an amount of generating moisture is also dominantly increased so that the output power tends to be decreased.

In a fuel cell using methanol as a fuel, a carbonic acid gas generated on the anode side hardly passes through the diffusion layer 16b, in which methanol is perfused. Therefore, output power must be decreased.

To improve aeration and ventilation, the diffusion layers 14b and 16b are made thinner or small holes are bored in the diffusion layers 14b and 16b. However, strength of the diffusion layers 14b and 16b must be lowered and areas contacting the catalyst must be smaller, so that suitable output characteristics cannot be gained.

### SUMMARY OF THE INVENTION

The present invention was conceived to solve the above described problems.

An object of the present invention is to provide methods of producing a composite material and a filter, which can be widely applied.

Another object is to provide a method of producing a diffusion layer of a fuel cell, which has high air permeability and is capable of well discharging moisture and a carbonic acid gas.

The method of producing a composite material, which is constituted by a substrate and a carbonized nanofiber layer, comprises the steps of:

disposing an electrically conductive substrate on an electrode plate of an electro spinning apparatus;

spraying a polymer solution or a molten polymer, to which high voltage is applied from a capillary of a capillary electrode of the electro spinning apparatus, toward the substrate on the electrode plate so as to form a large number of nanofibers on the substrate; and

burning the substrate, on which a large number of the nanofibers have been formed, so as to form a carbonized nanofiber layer on the substrate.

By disposing the electrically conductive substrate, which is formed by, for example, burning silk cloth, on the electrode plate of the electro spinning apparatus and spraying the polymer solution or the molten polymer, to which high voltage is applied from the capillary of the capillary electrode of the electro spinning apparatus, toward the substrate on the electrode plate so as to form the nanofiber layer, the nanofiber layer can be well adhered to the substrate. Drops of the high polymer, which are sprayed and positively charged, mutually repel, so that the high polymer is formed into the nanofibers. Upon reaching the electrically conductive substrate, the nanofibers are electrically grounded, so that the nanofiber layer can be tightly adhered to the substrate.

For example, the substrate is formed by burning a cloth-shaped silk material.

In the method, the polymer may be a synthetic polymer, such as rayon, polyacrylonitrile resin, phenol resin, polyamide resin and polyimide precursor, or a natural polymer, such as silk and cellulose.

The method of producing a filter, which is constituted by a substrate and a carbonized nanofiber layer, comprises the steps of:

disposing an electrically conductive substrate on an electrode plate of an electro spinning apparatus;

spraying a polymer solution or a molten polymer, to which high voltage is applied from a capillary of a capillary electrode of the electro spinning apparatus, toward the substrate on the electrode plate so as to form a large number of nanofibers on the substrate; and

burning the substrate, on which a large number of the nanofibers have been formed, so as to form a carbonized nanofiber layer on the substrate.

For example, the substrate is formed by burning a cloth-shaped silk material.

In the method, the polymer may be a synthetic polymer, such as rayon, polyacrylonitrile resin, phenol resin, polyamide resin and polyimide precursor, or a natural polymer, such as silk and cellulose.

The method of producing a diffusion layer of a fuel cell, in which a cathode layer and an anode layer, each of which has the diffusion layer and a catalyst layer, are located to sandwich an electrolytic membrane, the anode layers face the electrolytic membrane, and an oxidation-reduction reaction is caused by a fuel, such as hydrogen, and an oxidizing agent, such as oxygen, through the electrolytic membrane so as to generate an electromotive force, comprises the steps of:

disposing an electrically conductive substrate, which constitutes a part of the diffusion layer, on an electrode plate of an electro spinning apparatus;

spraying a polymer solution or a molten polymer, to which high voltage is applied from a capillary of a capillary electrode of the electro spinning apparatus, toward the substrate on the electrode plate so as to form a large number of nanofibers on the substrate; and

burning the substrate, on which a large number of the nanofibers have been formed, so as to form a carbonized nanofiber layer on the substrate.

The method may further comprise the step of forming the catalyst layer on the carbonized nanofiber layer.

In the method, the substrate may be formed by burning a cloth-shaped silk material.

In the method, the polymer may be a synthetic polymer, such as rayon, polyacrylonitrile resin, phenol resin, polyamide resin and polyimide precursor, or a natural polymer, such as silk and cellulose.

In the method, the burning step may include a primary burning step and a secondary burning step, and a temperature of the secondary burning step may be higher than that of the primary burning step.

In the present invention, the nanofiber layer is formed by disposing the electrically conductive substrate, which is formed by, for example, burning silk cloth, on the electrode plate of the electro spinning apparatus and spraying the polymer solution or the molten polymer, to which high voltage is applied from the capillary of the capillary electrode of the electro spinning apparatus, toward the substrate on the electrode plate, so that the nanofiber layer can be well adhered to the substrate. Namely, the drops of the high polymer, which are sprayed and positively charged, mutually repel, so that the high polymer is formed into the nanofibers. Upon reaching the electrically conductive substrate, the nanofibers are electrically grounded, so that the nanofiber layer can tightly adhere to the substrate. Further, the substrate is burned together with the nanofiber layer so as to further tightly adhere the carbonized nanofiber layer to the substrate. Therefore, the non peelable two-layer composite material can be produced. By forming the nanofibers with the electro spinning apparatus, a three-dimensional thin film (unwoven cloth) having stereoscopic meshes can be gained. The carbonized nanofiber layer, which is formed by burning the thin film, has high air permeability due to a slip flow effect.

The composite material having high air permeability can be used for not only various types of filters but also diffusion layers of fuel cells. The diffusion layer made of the composite material has following advantages: (1) the diffusion layer can be made thinner than conventional diffusion layers, and flooding of water generated on the cathode side can be restrained, so that characteristics of output power can be improved; (2) electric power collecting characteristics can be improved due to the dense carbonized nanofibers, so that loss of an electromotive force can be reduced; (3) unsticking the catalyst can be prevented due to the dense carbonized nanofibers, so that the diffusion layer can be used for a long time; and (4) a fuel can well permeate the diffusion layer due to the slip flow effect of the carbonized nanofibers, so that output efficiency of the fuel cell can be improved.

### BRIEF DESCRIPTION OF THE DRAWINGS

Embodiments of the present invention will now be described by way of examples and with reference to the accompanying drawings, in which:

FIG. 1 is a schematic explanation view of a cell structure of a fuel cell;

FIG. 2 is an electron micrograph of carbon fiber cloth formed by burning a knitted fabric of silk;

FIG. 3 is an FE-SEM graph of silk fibers burned at temperature of 2000° C.;

FIG. 4 is an electron micrograph of a surface of a conventional diffusion layer made of carbon paper;

FIG. 5 is an FE-SEM graph of a section of a carbon nanofabric layer;

FIG. 6 is a graph showing battery characteristics of the fuel cell of the embodiment;

FIG. 7 is a graph showing battery characteristics of a fuel cell of a comparative example; and

FIG. 8 is a schematic explanation view of the cell structure of the conventional fuel cell;

### DETAILED DESCRIPTION OF THE EMBODIMENTS

Preferred embodiments of the present invention will now be described in detail with reference to the accompanying drawings.

In the following description, diffusion layers of a fuel cell will be explained as the composite materials of the present invention.

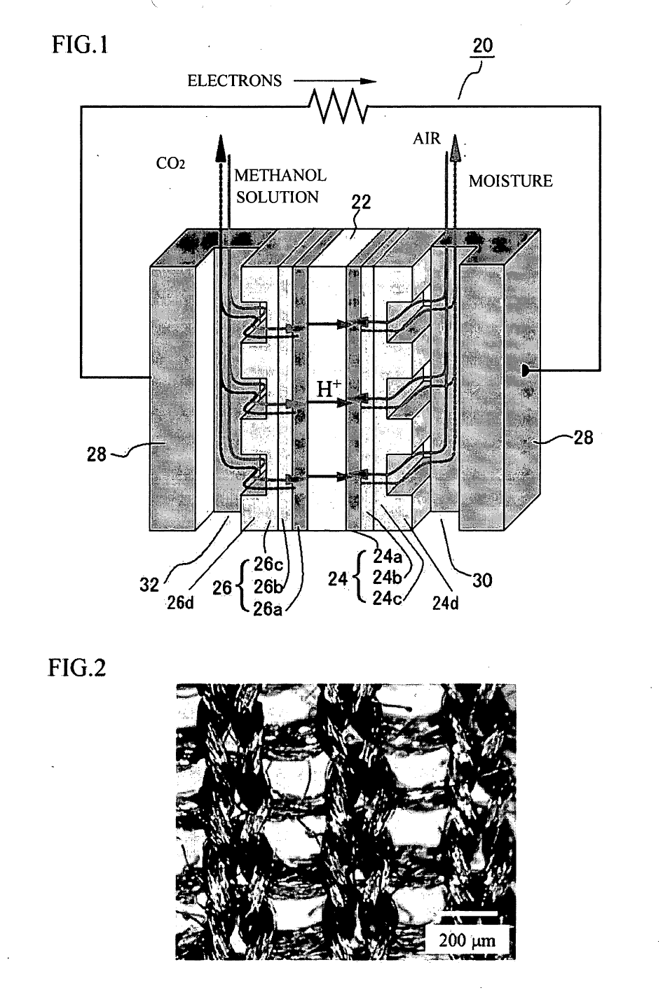

FIG. 1 is a schematic explanation view of a structure of a cell 20 of the fuel cell.

In the cell 20, a cathode layer 24 is formed on one side face of an electrolytic membrane 22; an anode layer (a fuel electrode) 26 is formed on the other side face thereof. Separators 28 are arranged to respectively face the cathode layer 24 and the anode layer 26. A plurality of parallel grooves are formed in a facing surface of each separator 28, which faces the cathode layer 24 or the anode layer 26. The grooves act as an air feeding path 30 and a fuel feeding path 32.

### Projected sections formed on the both sides of each groove contact the cathode layer 24 and the anode layer 26.

Air is fed to the air feeding path 30, and a fuel, e.g., hydrogen, methanol, is fed to the fuel feeding path 32, so that an oxidation-reduction reaction occurs through the electrolytic membrane 22 and an electromotive force can be generated.

Note that, the type of the fuel cell is not limited.

Catalyst layers 24a and 26a, which support a catalystic metal for accelerating an electrode reaction, are respectively formed on the cathode layer 24 and the anode layer 26 and arranged to face the electrolytic membrane 22. Carbonized nanofiber layers 24b and 26b are respectively formed on the other sides of the catalyst layers 24a and 26a. Further, carbonized conductive layers (electrically conductive substrates) 24c and 26c are formed on the other sides of the carbonized nanofiber layers 24b and 26b. The carbonized conductive layers 24c and 26c respectively face the air feeding path and the fuel feeding path. In the present embodiment, the carbonized nanofiber layer 24b and the carbonized conductive layer 24c constitute the diffusion layer of the cathode layer 24; the carbonized nanofiber layer 26b and the carbonized conductive layer 26c constitute the diffusion layer of the anode layer 26.

Next, the cathode layer 24 and the anode layer 26 will be explained.

The carbonized conductive layers (substrates) 24c and 26c are made of carbon fiber cloth having projected sections 24d and 26d, which are outwardly projected from side faces on the feeding sides to which a fuel and an oxidizing agent is fed.

At least one carbonized conductive layer is formed in the cathode layer 24 or the anode layer 26. In the embodiment shown in FIG. 1, the projected sections 24d and 26d are formed in the both of the cathode layer 24 and the anode layer 26.

The projected sections 24d and 26d may be independent small projections. Preferably, the projected sections 24d and 26d are formed like ribs as shown in FIG. 1, and the rib-shaped projected sections 24d and 26d are extended in the directions intersecting with the air feeding direction and the fuel feeding direction.

By forming the projected sections 24d and 26d in the carbonized conductive layers 24c and 26c, spaces are formed between the projected sections 24d and 26d and paths are formed, so that air permeability can be improved. Therefore, moisture generated on the cathode layer 24 side can be easily discharged outside via the spaces formed between the projected sections 24d and the feeding path 30. Clogging of the carbonized conductive layer 24c, which is caused by condensing moisture, can be highly prevented, and air can well permeate the carbonized conductive layer 24c, so that the electrode reaction can be accelerated and output power can be increased. Especially, the projected sections 24d are formed like ribs, and the ribs (the grooves) are extended in the direction intersecting with the feeding path 30. With this structure, the grooves are communicated to the feeding path 30, so that air can be supplied to the entire surface of the carbonized conductive layer 24c, so that air can well permeate the carbonized conductive layer 24c and the electrode reaction can be highly accelerated.

Similarly, in case of using methanol as a fuel, a carbonic acid gas generated on the anode layer 26 side is easily discharged outside via the spaces between the projected sections 24d and the feeding path 32. Therefore, retain of the carbonic acid gas can be prevented, and the electrode reaction can be accelerated.

The carbonized conductive layers (substrates) 24c and 26c made of the carbon fiber cloth (electrically conductive material) having the projected sections 24d and 26d are formed by, for example, burning knitted fabrics of silk. FIG. 2 is an electron micrograph of carbon fiber cloth formed by burning a knitted fabric of silk. In case of using such a knitted fabric, rib-shaped projected sections (projected sections extending in the vertical direction in FIG. 2) are formed on one side face of the fabric, and spaces formed between the projected sections can be clearly observed. The other side face of the fabric is a relatively flat face with no projected sections.

By burning the fabric, the rib-shaped projected sections can be formed. Further, for example, carbon fiber cloth having independent projected sections can be formed by burning a fabric including many independent projections (not shown).

Silk cloth, e.g., knitted fabric, is burned at high temperature, e.g., 1000-3000° C.

The burning is performed in an inert gas atmosphere, e.g., nitrogen gas atmosphere, argon gas atmosphere, or in a vacuum atmosphere so as not to incinerate the silk material.

The burning is performed by stages so as to avoid rapid burning. For example, temperature for burning the silk cloth is gradually increased 100° C. or less/hour, preferably 50° C. or less/hour, until reaching a primary burning temperature, e.g., 500° C., and the primary burning temperature is maintained for several hours (a primary burning step). Next, the burned silk is once cooled until reaching the room temperature, and then the burned silk is burned again. Burning temperature is gradually increased 100° C. or less/hour, preferably 50° C. or less/hour, until reaching a secondary burning temperature, and the secondary burning temperature is maintained for several hours (a secondary burning step). Next, the burned silk is cooled again until reaching the room temperature, and then the burned silk is further burned. The silk cloth, which has been secondary-burned, is similarly burned at a tertiary burning temperature (final burning temperature), e.g., 2000° C., so that a silk burned body can be produced. Note that, the burning conditions are not limited to the above described example. The conditions may be determined on the basis of kinds of silk, functions of a silk burned body, etc.

By burning the silk cloth by stages and gradually increasing the temperature, rapidly decomposing high order architectures of proteins of dozens of amino acids, in which amorphous architectures and crystalline architectures are involved, can be prevented, and a flexible and glossy black silk burned body can be produced.

The burning is performed at temperature of 1000-3000° C. Especially, by burning at temperature of 1000° C. or above, the burned body is graphitized and has high electric conductivity. Namely, the burned body can be used as a superior electrode material.

A thickness, density, etc. of the silk material can be optionally controlled by changing thicknesses of strings (yarns), types of twisting yarns, types of knitting yarns, types of weaving yarns and a thickness of unwoven cloth. Therefore, air permeability (fuel permeability and gas permeability) of the silk burned body can be optionally controlled.

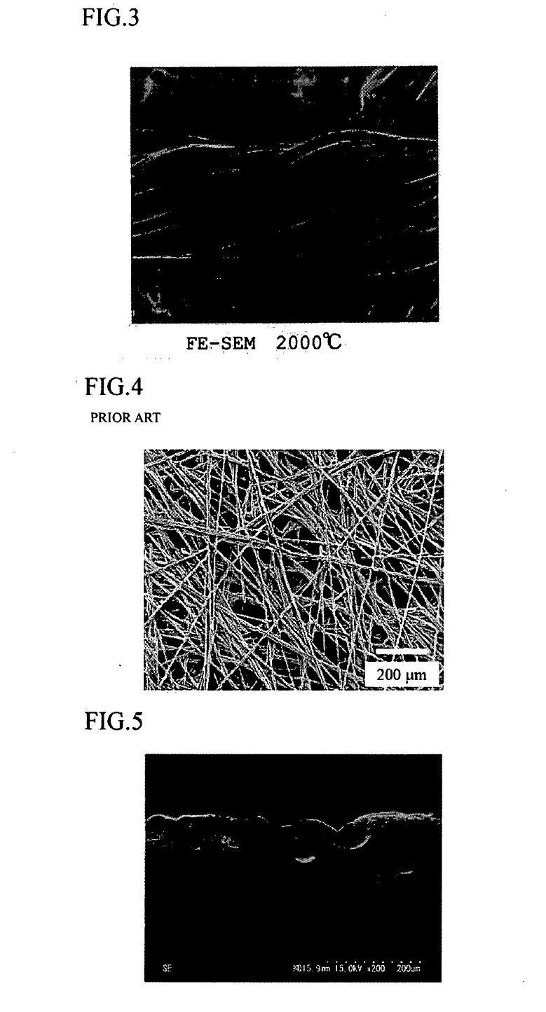

As shown in an FE-SEM graph of FIG. 3, proper spaces are formed between yarns, each of which is constituted by the fibers, or twisted yarns of the silk burned body, which is produced by burning the silk material. Therefore, contact efficiency of air and fuel can be improved, so that stable electromotive force can be generated.

In the above description, the silk burned body, which is produced by burning the silk material, is used as an electrically conductive member forming the carbonized conductive layers, but the electrically conductive member is not limited to the silk burned body. For example, carbon fiber cloth, in which projected sections are formed in one side face, can be formed by burning a knitted fabric of synthetic resin fibers, e.g., acrylonitrile fibers, phenol fibers.

The carbonized conductive layers 24c and 26c may be made of conventional carbonized conductive materials, e.g., carbon paper, carbon cloth. FIG. 4 is an electron micrograph of a surface of the conventional diffusion layer made of carbon paper. Carbon fibers are mutually overlapped and extended in random directions. Both of the side faces are relatively flat, and no projected sections are formed.

On the other hand, in the present embodiment, the carbonized nanofiber layers 24b and 26b are respectively formed, as the diffusion layers, on the one side faces of the carbonized conductive layers (substrates) 24c and 26c.

For example, the carbonized nanofiber layers may be formed by the steps of: electro-spinning a synthetic polymer, e.g., rayon, polyacrylonitrile resin, phenol resin, polyamide resin, polyimide precursor, or a natural polymer, e.g., silk, cellulose, so as to form microfine fibers, whose thicknesses are nano level; forming cloth, e.g., woven cloth, knitted fabric, unwoven cloth, with the microfine fibers; and burning the cloth in an inert gas atmosphere.

The electro spinning process is a known technology. In the present embodiment, the carbonized conductive layers (substrates) 24c and 26c, each of which constitutes a part of the diffusion layer, are disposed on an electrode plate of an electro spinning apparatus (not shown). Next, a polymer solution, to which high voltage is applied from a capillary of a capillary electrode of the electro spinning apparatus, is sprayed toward the carbonized conductive layers (substrates) 24c and 26c so as to form a large number of nanofibers on the carbonized conductive layers (substrates) 24c and 26c.

And then, the carbonized conductive layers (substrates) 24c and 26c, on which the nanofibers have been formed, are burned so as to form the carbonized nanofiber layers on the carbonized conductive layers (substrates) 24c and 26c.

The thicknesses of the fibers, which have been formed by the electro spinning process, depend on applied voltage, concentration of the solution and a spraying distance. These conditions are not limited. The preferable concentration of the solution is 2-12 wt %, more preferably 6-8 wt %; the preferable applied voltage is 4-18 kV, more preferably 10-15 kV; and the preferable spraying distance is 2-20 cm, more preferably 6-10 cm. By selecting the preferable conditions, nanofibers whose thicknesses are several hundred nm can be formed.

To improve adhesiveness between the nanofibers and the carbonized conductive layers (substrates) 24c and 26c, surfaces of the silk materials, e.g., silk woven cloth, are raised before the burning step. The raising treatment may be performed by purposely damaging the silk woven cloth so as to raise fine fibers. By burning the raised silk materials to form the carbonized conductive layers (substrates) 24c and 26c, the nanofibers, which have been formed by the electro spinning process, can be easily and securely adhered.

For example, the raising treatment may be performed by rolling a comb-shaped roller on the surfaces of the silk materials to damage and raise the surfaces (a shirring method) or by applying water to the silk materials and rubbing the wet silk materials together to raise the surfaces thereof.

After forming the nanofibers, a nonmeltable treatment is performed at temperature of 250° C. for six hours. Next, the carbonized conductive layers (substrates) 24c and 26c, on which the nanofibers have been formed, are burned. For example, the primary burning is performed at relatively low temperature of 500-1000° C. for several hours, more preferably at temperature of 600-900° C. for 3-10 hours, in an inert gas atmosphere; and then, the secondary burning is performed at relatively high temperature of 1200-2000° C. for 1-6 hours for graphitizing.

Since the nanofibers are formed by the electro spinning process, three-dimensional thin films (unwoven cloth) having stereoscopic meshes can be gained. Therefore, the carbonized nanofiber layers 24b and 26b, which are formed by burning the thin films, have high air permeability due to a slip flow effect. Namely, gas molecules slip-flow in the carbonized nanofiber layers 24b and 26b, which are constituted by the microfine fibers, so that pressure loss can be reduced, a fuel and air can be well diffused and easily contact the catalysts. Therefore, the output power can be increased.

Since the nanofiber layers are formed on the carbonized conductive layers (substrates) 24c and 26c by the electro spinning process, the diffusion layers can well adhere to the carbonized conductive layers (substrates) 24c and 26c.

Note that, the diffusion layers are formed by, for example, forming the nanofiber layers on unburned silk materials (cloth) with electro spinning and burning the nanofiber layers together with the silk materials. With this step, the diffusion layers, each of which is constituted by the carbonized conductive layer (substrate) and the carbonized nanofiber layer, can be formed. By simultaneously burning the silk materials and the nanofiber layers, the production steps can be reduced.

However, the above described method has a following problem.

Namely, the unburned silk cloth is a nonconductive substance. If the unburned silk cloth is disposed on an electrode plate (ground) of the electro spinning apparatus and the electro spinning process is performed, positively-charged drops mutually repel and they are formed into fibers. However, the fibers sticking on the silk cloth are still charged and mutually repel, so that adhesiveness of the fibers to the silk cloth must be low. Even if the silk cloth is burned together with the fibers, the carbonized nanofiber layer is easily peeled from the carbonized conductive layer (substrate).

Thus, in the present embodiment, the nanofiber layers are respectively formed on the carbonized conductive layers (substrates) 24c and 26c by the electro spinning process, so that the nanofiber layers can be well adhered to the carbonized conductive layers (substrates) 24c and 26c. The drops of the high polymer, which are sprayed and positively charged, mutually repel, so that the high polymer is formed into the nanofibers. Upon reaching the carbonized conductive layers (substrates) 24c and 26c, the nanofibers are immediately electrically grounded because the carbonized conductive layers (substrates) 24c and 26c have electric conductivity. Therefore, the nanofiber layers can be tightly adhered to the carbonized conductive layers (substrates) 24c and 26c. Thus, the carbonized nanofiber layers 24b and 26b can be well adhered to the carbonized conductive layers (substrates) 24c and 26c.

The carbonized nanofiber layers are constituted by the microfine carbon fibers. Thus, the catalyst layers 24a and 26a may be formed, for example, by making the carbonized nanofiber layers directly support a catalystic metal or by making carbon nanofibers, e.g., VGCF®, supporting a catalystic metal, e.g., platinum, platinum-ruthenium, mixing the carbon nanofibers supporting the catalystic metal with a solvent, e.g., a nafion solution, so as to form into paste and applying the paste to the carbonized nanofiber layers.

Suitable catalystic metals are platinum, platinum alloy, platinum-ruthenium, gold, palladium, etc.

A method of supporting the catalystic metal will be explained.

For example, in case of using platinum, the diffusion layers are soaked into a nitric acid solution or a hydrogen peroxide solution as a pretreatment, the diffusion layers are dried, and then a chloroplatinic acid solution is applied to the dried diffusion layers or the dried diffusion layers are soaked into the chloroplatinic acid solution. With this method, platinum can be supported by the carbonized nanofiber layers 24b and 26b of the diffusion layers.

In another case, the catalyst layers 24a and 26a may be formed by the steps of: making carbon powder supporting the catalystic metal, e.g., platinum, platinum-ruthenium; mixing the carbon powder supporting the catalystic metal with a solution, e.g., nafion solution, so as to form into paste: applying the paste a surface (one side face) of a sheet-shaped carbon fiber cloth; and warming the carbon fiber cloth so as to volatilize the solution. With this method, the catalyst layers 24a and 26a can be formed.

Further, the catalyst layers 24a and 26a may be formed by the steps of: making carbon nanofibers, e.g., VGCF® supporting the catalystic metal, e.g., platinum, platinum-ruthenium; mixing the carbon nanofibers supporting the catalystic metal with a solution, e.g., nafion solution, so as to form into paste: applying the paste a surface (one side face) of a sheet-shaped silk burned body; and warming the silk burned body so as to volatilize the solution. With this method, the catalyst layers 24a and 26a can be formed.

Note that, the catalystic metal must contact the carriers (carbon fibers) and the electrolytic membrane 22. Since the catalystic metal must high-densely contact the both members, power generating efficiency can be improved. For example, the carriers are made of the high density material, e.g., carbonized nanofiber layer, so that the carriers can high-densely contact the catalyst layers and the catalystic metal can be high-densely supported by the carriers. Further, undesirable diffusion of the microfine catalyst layers can be prevented.

In the above describe embodiment, the diffusion layers of the fuel cell have been explained as the burned composite material including the conductive substrates and the carbonized nanofiber layers, but the burned composite material may be applied to other uses. For example, the carbonized nanofiber layer per se is capable of absorbing various gasses, so it may be suitably used as a filter. Especially, if the filter includes a burned silk material as the substrate, nitrogen derived from amino acid exists therein, so that the substrate per se has a superior absorption effect. Therefore, the superior filter material, which entirely has superior absorption effect, can be produced.

### [Embodiment]

### (Production Process of Conductive Substrate)

A silk material was heated until reaching 700° C. with a temperature rising rate of 50° C./hour, and then the temperature was maintained six hours in a nitrogen atmosphere so as to produce an electrically conductive substrate.

### (Electro Spinning Process)

The conductive substrate was disposed on an earth electrode of an electro spinning apparatus. A dimethylformamide solution including 8 wt % of polyacrylonitrile was electrolytic-spun with voltage of 15 kV so as to form a nanofabric layer.

### (Burning Conductive Substrate and Nanofabric Layer)

The conductive substrate, on which the nanofabric layer had been formed, was heated until reaching 250° C. with a temperature rising rate of 50° C./hour, and then the temperature was maintained for six hours in the air as the nonmeltable treatment.

Next, the conductive substrate was reheated until reaching 700° C. with a temperature rising rate of 50° C./hour, and then the temperature was maintained for six hours in the nitrogen atmosphere so as to perform the primary burning.

Further, the primary-burned conductive substrate having the nanofiber layer was heated until reaching 1400° C. with a temperature rising rate of 500° C./hour, and then the temperature was maintained for three hours in the nitrogen atmosphere so as to perform the secondary burning.

By the burning steps, a highly-adhered composite material (carbon nanofabric layer) was produced. An FE-SEM graph of a section of the carbon nanofabric layer is shown in FIG. 5.

### (Process of Producing Fuel Cell)

An electrolytic membrane, in which a Pt—Ru catalyst was applied to an anode and a Pt catalyst was applied to a cathode by a transfer method, was prepared. An amount of the supported Pt in the anode or the cathode was 1.0 mg/cm2. The carbon nanofabric layer was sandwiched between a catalyst layer and carbon paper (TGP-H-060 manufactured by Tore) on the cathode side; no carbon nanofabric layer was sandwiched between a catalyst layer and carbon paper (TGP-H-060 manufactured by Tore) on the anode side. With this structure, a fuel cell was completed.

### (Evaluation of Fuel Cell)

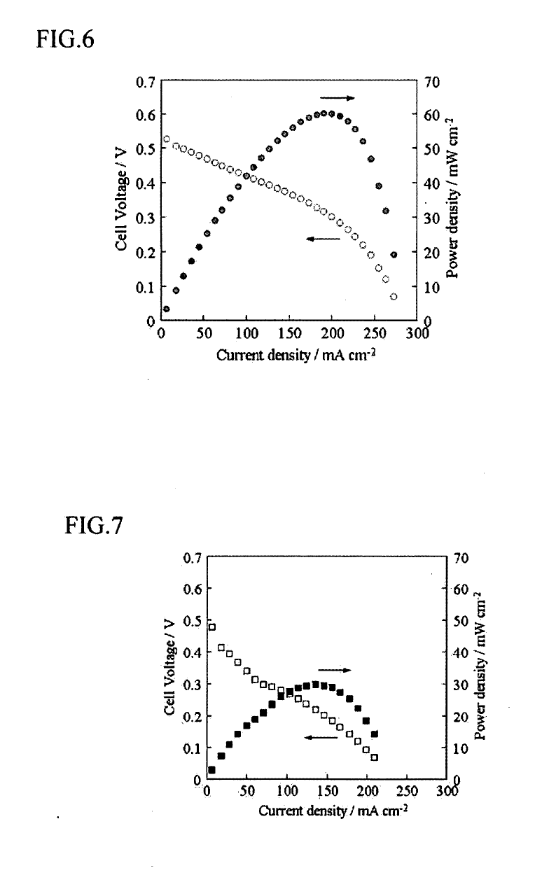

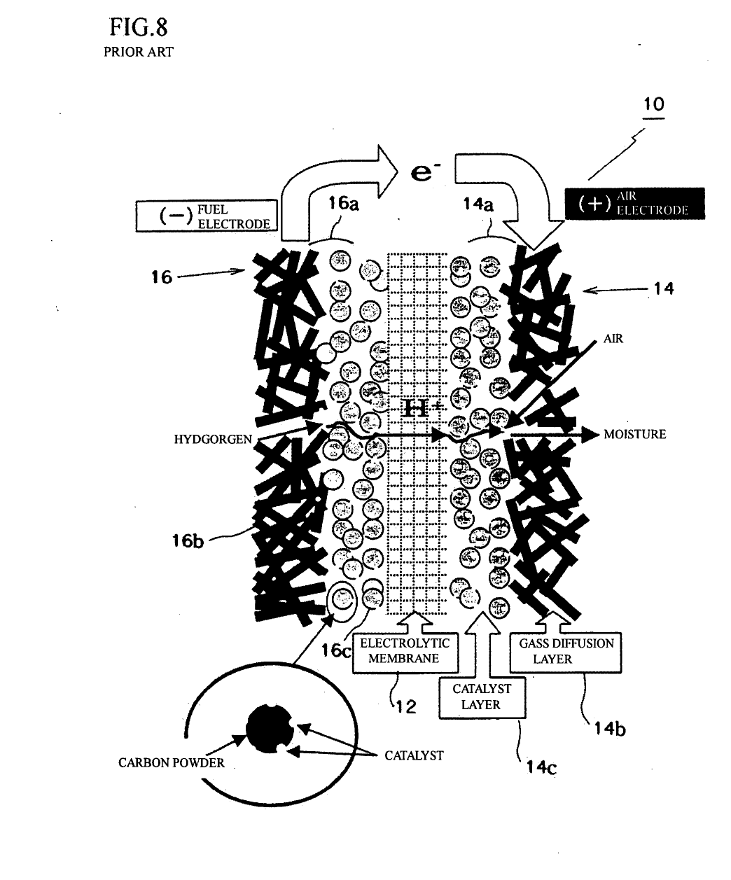

The completed fuel cell was attached to a fuel cell evaluation apparatus (manufactured by Toyo Technica). A 1.5M methanol solution was supplied to the anode side at a flow speed of 2.8 ml/minute; air was supplied to the cathode side at a flow speed of 500 ml/minute. A cell temperature was 60° C. Output power of the fuel cell was evaluated under such conditions. Maximum output power density of the fuel cell of the experimental example was 62 mW/cm² (see FIG. 6).

A fuel cell, in which no carbon nanofabric layer was included on the cathode side, was produced as a comparative example. Output power of the fuel cell was evaluated under the same conditions. Maximum output power density of the fuel cell of the comparative example was 30 mW/cm² (see FIG. 7).

The evaluations (see FIGS. 6 and 7) clearly indicate that the output power of the fuel cell of the experimental example can be highly increased by employing the carbon nanofabric layer made by the electro spinning apparatus. The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a composite material, which is constituted by a substrate and a carbonized nanofiber layer,
comprising the steps of:
disposing an electrically conductive substrate on an electrode plate of an electro spinning apparatus;
spraying a polymer solution or a molten polymer, to which high voltage is applied from a capillary of a capillary electrode of the electro spinning apparatus, toward the substrate on the electrode plate so as to form a large number of nanofibers on the substrate; and
burning the substrate, on which a large number of the nanofibers have been formed, so as to form a carbonized nanofiber layer on the substrate.

2. The method according to claim 1,
wherein the substrate is formed by burning a cloth-shaped silk material.

3. The method according to claim 1,
wherein the polymer is a synthetic polymer, such as rayon, polyacrylonitrile resin, phenol resin, polyamide resin and polyimide precursor, or a natural polymer, such as silk and cellulose.

4. The method according to claim 2,
wherein the polymer is a synthetic polymer, such as rayon, polyacrylonitrile resin, phenol resin, polyamide resin and polyimide precursor, or a natural polymer, such as silk and cellulose.

5. A method of producing a filter, which is constituted by a substrate and a carbonized nanofiber layer,
comprising the steps of:
disposing an electrically conductive substrate on an electrode plate of an electro spinning apparatus;
spraying a polymer solution or a molten polymer, to which high voltage is applied from a capillary of a capillary electrode of the electro spinning apparatus, toward the substrate on the electrode plate so as to form a large number of nanofibers on the substrate; and
burning the substrate, on which a large number of the nanofibers have been formed, so as to form a carbonized nanofiber layer on the substrate.

6. The method according to claim 5,
wherein the substrate is formed by burning a cloth-shaped silk material.

7. The method according to claim 5,
wherein the polymer is a synthetic polymer, such as rayon, polyacrylonitrile resin, phenol resin, polyamide resin and polyimide precursor, or a natural polymer, such as silk and cellulose.

8. The method according to claim 6,
wherein the polymer is a synthetic polymer, such as rayon, polyacrylonitrile resin, phenol resin, polyamide resin and polyimide precursor, or a natural polymer, such as silk and cellulose.

9. A method of producing a diffusion layer of a fuel cell, in which a cathode layer and an anode layer, each of which has the diffusion layer and a catalyst layer, are located to sandwich an electrolytic membrane, the catalyst layers face the electrolytic membrane, and an oxidation-reduction reaction is caused by a fuel, such as hydrogen, and an oxidizing agent, such as oxygen, through the electrolytic membrane so as to generate an electromotive force,
comprising the steps of:
disposing an electrically conductive substrate, which constitutes a part of the diffusion layer, on an electrode plate of an electro spinning apparatus;
spraying a polymer solution or a molten polymer, to which high voltage is applied from a capillary of a capillary electrode of the electro spinning apparatus, toward the substrate on the electrode plate so as to form a large number of nanofibers on the substrate; and
burning the substrate, on which a large number of the nanofibers have been formed, so as to form a carbonized nanofiber layer on the substrate.

10. The method according to claim 9,
further comprising the step of forming the catalyst layer on the carbonized nanofiber layer.

11. The method according to claim 9,
wherein the substrate is formed by burning a cloth-shaped silk material.

12. The method according to claim 9,
wherein the polymer is a synthetic polymer, such as rayon, polyacrylonitrile resin, phenol resin, polyamide resin and polyimide precursor, or a natural polymer, such as silk and cellulose.

13. The method according to claim 11,
wherein the polymer is a synthetic polymer, such as rayon, polyacrylonitrile resin, phenol resin, polyamide resin and polyimide precursor, or a natural polymer, such as silk and cellulose.

14. The method according to claim 9,
wherein said burning step includes a primary burning step and a secondary burning step, and
a temperature of the secondary burning step is higher than that of the primary burning step.
